(19) United States
(12) Patent Application Publication
(10) Pub. No.: US 2024/0332984 A1
(43) Pub. Date: Oct. 3, 2024

(54) SYSTEMS AND METHODS FOR DISTRIBUTING POWER BETWEEN VEHICLE CHARGERS AND HASHED DATA CONVERSION

(71) Applicant: Kennedy Mining LLC, Pensacola, FL (US)

(72) Inventors: Mikal E. Kissick, Pensacola, FL (US); Michael M. Aitken, Pensacola, FL (US); Reed Mitchell Morrison, Newport Beach, CA (US)

(21) Appl. No.: 18/620,781

(22) Filed: Mar. 28, 2024

Related U.S. Application Data
(60) Provisional application No. 63/493,138, filed on Mar. 30, 2023.

(51) Int. Cl. H02J 7/00; B60L 53/16; B60L 53/18; B60L 53/66; B60L 53/68; G06F 21/31; G06Q 20/30; G06Q 50/06

(52) U.S. Cl. CPC H02J 7/00032; B60L 53/665; B60L 53/68; G06F 21/31; G06Q 20/30; G06Q 50/06; B60L 53/16; B60L 53/18

(57) ABSTRACT

An electrical energy redirection system that efficiently utilizes electrical power and enhances performance of graphics processing unit, system comprising an electrical charging interface configured to couple to corresponding receiving interface of electric vehicle and charge vehicle's battery; a data interface receives authorization for charging battery from remote computing device; a graphics processing unit receives hashed data strings and determines original data input from them; an air vent prevents environmental debris from contacting graphics processing unit and cools it by directing outdoor air toward it; a power switching unit includes electronic sensor that identifies when charging interface is coupled to receiving interface and charging battery; an electronic processor executes instructions to redirect electrical power from power source to graphics processing unit when electrical load is below charging threshold and transmits signal to cause graphics processing unit to calculate original data input.

### INCORPORATION BY REFERENCE

Any and all applications for which a foreign or domestic priority claim is identified in the Application Data Sheet as filed with the present application are hereby incorporated by reference under 37 CFR 1.57.

### BACKGROUND

### Field of the Disclosure

The disclosed subject matter relates to electric vehicle charging stations, and more specifically, systems and methods for charging electric vehicles and redirecting excess electric power to hashed string conversion (e.g., blockchain execution, currency mining, etc.) machines integrated into the electric vehicle charging station. The hashed string conversion machines may include a graphics processing unit.

### Description of the Related Art

Electric Vehicles (EVs) are increasingly being used as a desirable mode of transportation for society and the environment. Governments are actively encouraging the adoption of electric vehicles, and automobile manufacturers are transitioning from traditional internal combustion engines to electric vehicles. Many already have established plans to do so within a few years. However, adequate infrastructure must be to support electric vehicle charging, particularly in rural areas. In addition, the availability of charging stations is not sufficiently widespread, resulting in significant peaks and troughs in demand for charging power. This variability in demand may result in sudden high and urgent demand for charging power, followed by long periods of charging inactivity. The inactive or idle time for charging stations may be beneficially put to use.

### SUMMARY

The following presents a summary of the disclosure in order to provide a basic understanding of the technology. This summary is not an extensive overview of the disclosure and it does not identify any key/critical elements of the invention or delineate the scope of the invention.

Described herein are embodiments of a system for charging electric vehicles and redirecting excess electric power to, for example, machines for determining original data from hashed strings or other machines, including energy-intensive machines.

In some embodiments, a system charges a battery of electric vehicles when the battery connects to a corresponding receiving interface of an electric vehicle outdoors. The system can connect an electrical charging interface to a corresponding receiving interface of the electric vehicle and charge the electric vehicle battery by the electrical charging interface in a coupled configuration. Additionally or alternatively, the system does not direct the electrical energy to the receiving interface of the electric vehicle from the electrical charging interface in an uncoupled configuration.

In some embodiments, the system enables a data interface to transmit a verification signal from a user interface to a remote computing device to receive user credentials. The system can enable a display interface to receive user credentials. In some embodiments, the system enables the data interface to receive authorization from the remote computing device for charging the electric vehicle's battery in response to receiving the user credentials. The system can receive user selection via the display interface to enable charging the electric vehicle's battery in the coupled configuration. In some embodiments, the system enables a graphics processing unit to receive a hashed data string with a fixed length and to determine an original data input. In some embodiments, the system includes air vents to prevent environmental debris from contacting the graphics processing unit.

In some embodiments, the system includes air vents to direct ambient outdoor air toward the graphics processing unit, thereby cooling the graphics processing unit. In some embodiments, the system includes an electronic sensor to identify when the electrical charging interface is coupled to the corresponding receiving interface and charging the electric vehicle's battery. In some embodiments, the system includes an electronic processor to receive an indication of an electrical load on the electrical charging interface from the electronic sensor. The system may include the electronic processor to determine whether the electrical load is below a charging threshold.

In some embodiments, the system redirects electric power from the electrical power source to the graphics processing unit instead of to the electrical charging interface based on determining the electrical load below a charging threshold. The system can transmit a signal to enable the graphics processing unit to calculate the original input from the hashed data string. The system may offer an improved energy redirection system that efficiently utilizes electrical power and enhances the performance of the graphics processing unit.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1A is a block diagram depicting a system for charging vehicles and redirecting excess electric power to hashed string conversion machines, in accordance with one or more exemplary embodiments.

FIG. 1B is a block diagram depicting an example charging station, in accordance with one or more exemplary embodiments.

FIG. 1C is a diagram depicting a system for charging electric vehicles and redirecting excess electric power to hashed string conversion machines, in accordance with one or more exemplary embodiments.

FIG. 1D is another block diagram depicting an example electric charging system for charging electric vehicles and redirecting excess electric power, in accordance with one or more exemplary embodiments.

FIG. 1E is an example block diagram of a system including a hashed data conversion machine, in accordance with one or more exemplary embodiments.

FIG. 1F is another block diagram showing a system that includes the charging station and the computing device, in accordance with one or more exemplary embodiments.

FIG. 2 is a block diagram depicting a system in which aspects of the present disclosure can be implemented. FIG. 2 depicts a schematic representation of an electrical energy redirection system, in accordance with one or more exemplary embodiments.

FIG. 3A is an example diagram depicting a first-level integrated charging station, in accordance with one or more exemplary embodiments.

FIG. 3B, FIG. 3C show example diagrams depicting a second-level charging station with four chargers and a second-level charging station with two chargers, in accordance with one or more exemplary embodiments.

FIG. 3D is an example diagram depicting a third-level charging station, in accordance with one or more exemplary embodiments.

FIG. 4 is an example diagram depicting the electric charger or the charger cable and charging plug of the charging station, in accordance with one or more exemplary embodiments.

FIG. 5A, FIG. 5B show example diagrams depicting the hashed data conversion machine of the charging station, in accordance with one or more exemplary embodiments.

FIG. 5C is an example diagram depicting a motherboard of the hashed data conversion machine, in accordance with one or more exemplary embodiments.

FIG. 6 is an example diagram depicting a prototype of the charging station, in accordance with one or more exemplary embodiments.

FIG. 7 is an example flow diagram depicting a method for redirecting electric power from a graphics processing unit to an electrical charging interface, in accordance with one or more exemplary embodiments.

FIG. 8 is an example flow diagram depicting a method for generating digital currency and charging electric vehicles, in accordance with one or more exemplary embodiments.

FIG. 9 is an example flow diagram depicting a method for simultaneous hashed data conversion and charging electric vehicles, in accordance with one or more exemplary embodiments.

FIG. 10 is another example flow diagram depicting a method for simultaneous hashed data conversion and charging electric vehicles, in accordance with one or more exemplary embodiments.

FIG. 11 is a block diagram illustrating the details of a digital processing system in which various aspects of the present disclosure are operative by the execution of appropriate software instructions.

Furthermore, the objects and advantages of this invention will become apparent from the following description and the accompanying annexed drawings.

### DETAILED DESCRIPTION

Electric vehicle charging stations provide the recharging infrastructure for numerous electric vehicles. These charging stations can be located in designated areas similar to gas stations, public and private parking spaces, and homes and workplaces. Almost all electric plug-in vehicles have onboard charger systems that accept 110 Volt or 220 Volt charging outputs. Most draw electric power at current levels from 10 to 70 Amps, while charging stations draw power at much higher levels. Electric vehicle charging stations receive electric power from a local distribution transformer or a power grid. However, the excess electric power received by charging stations from the local transformer or power grid is not directed, shared, or utilized by conventional charging stations.

Graphics Processor Units (GPUs) of a computer can be used to convert hashed data (e.g., execute blockchain calculations), which produces a significant amount of heat as a byproduct. Therefore, hashed data conversion operations are typically conducted indoors in air-conditioned environments, as excessive heat can degrade the performance of GPUs and must be dissipated. In addition, operating and maintaining servers can be expensive, requiring significant computing power and electricity consumption and resulting in high operating costs and reducing the profitability of the hashed data conversion operation. Therefore, there is a need to develop an integrated system to charge electric vehicles and redirect excess electric power to hashed data conversion machines to generate digital currency. It may be beneficial to use a plurality of GPUs and/or one or more special purpose processors for performing the computationally intensive tasks that may be executed with excess or unused electrical power (e.g., converting hashed data strings). Special purpose processors can be configured to execute specific computations or solve specific computations. In some cases, the special purpose processors or other processors described herein may utilize parallel computing processors to execute complex mathematical computations, such as matrix calculations.

In light of the aforementioned discussion, there is a need for a system with novel methodologies that can overcome the aforementioned limitations and challenges in the field of electric vehicle charging stations and other electric charging systems.

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising”, or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

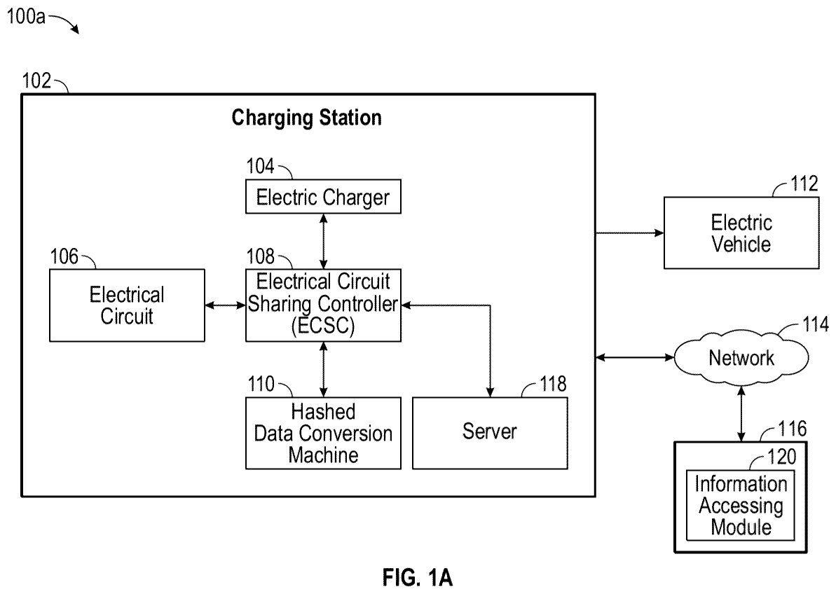

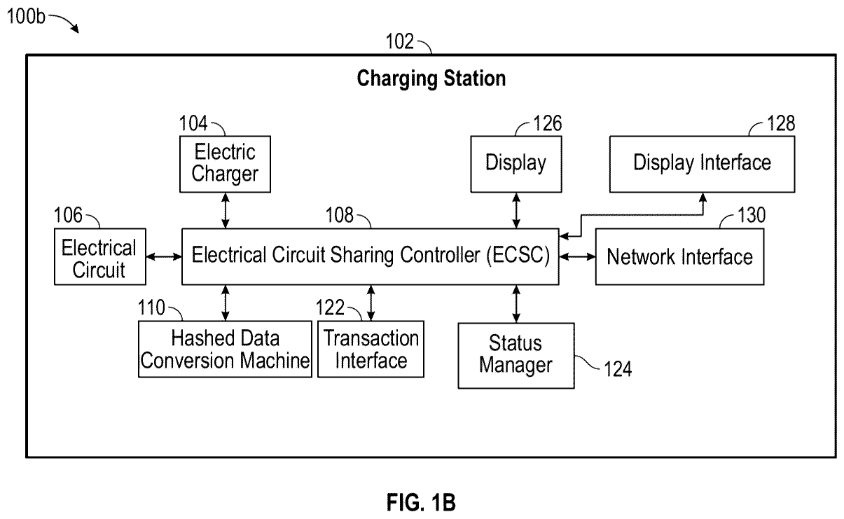

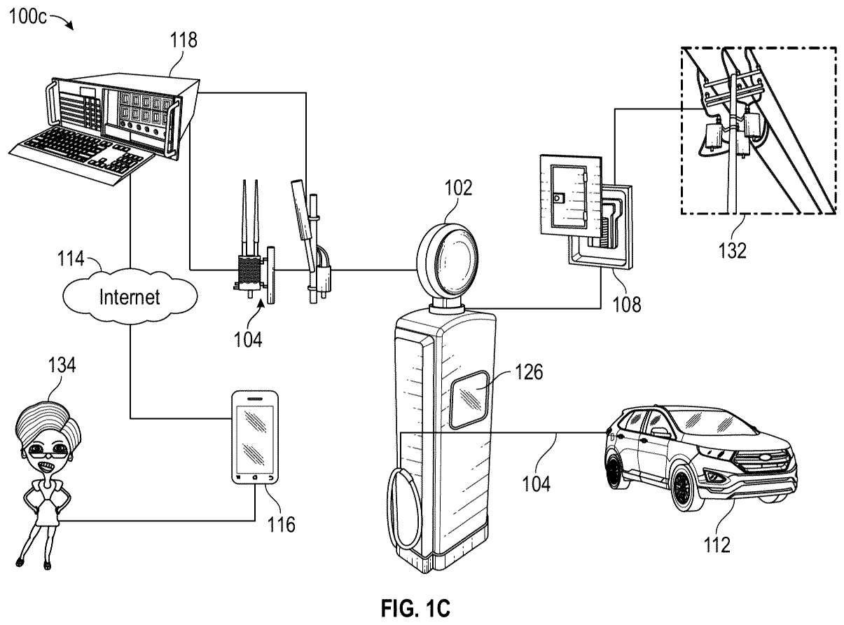

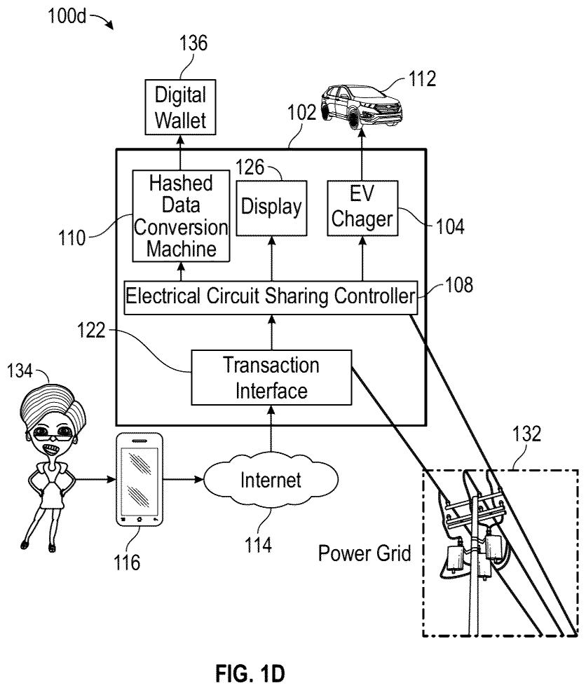

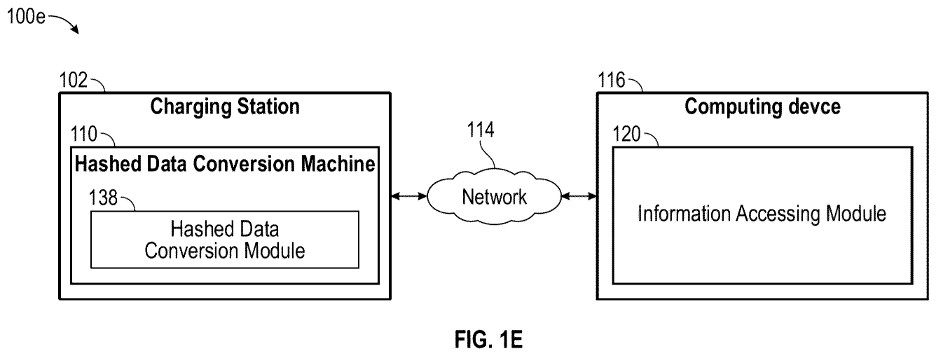

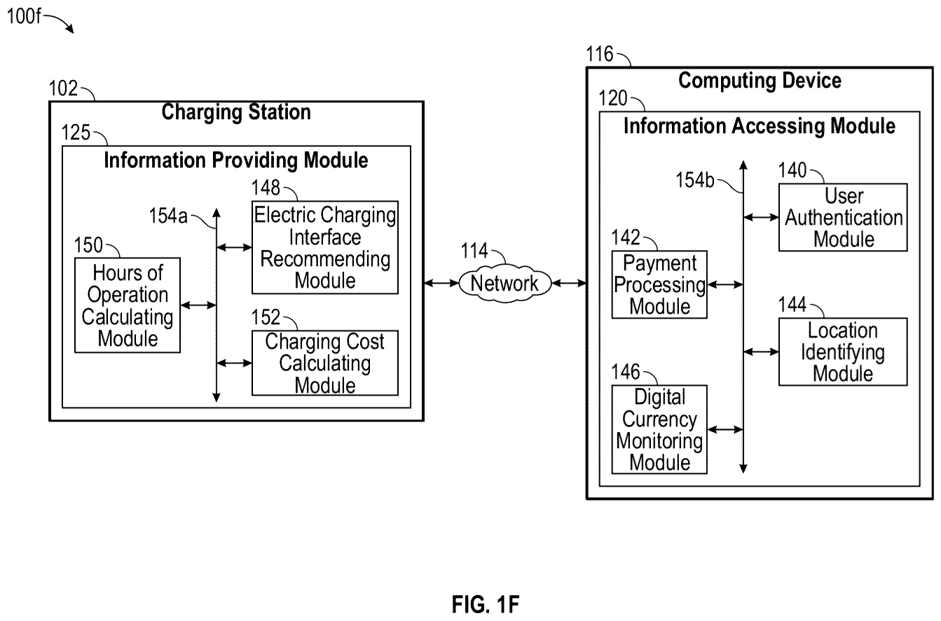

FIG. 1A is a block diagram 100a depicting an integrated electric charging system for charging vehicles (or other electric devices) and redirecting excess electric power to currency mining machines, in accordance with one or more exemplary embodiments. Although reference to electric vehicles is used herein, reference to other electric devices is to be understood. The system 100a depicts a charging station 102, an electric charger or a charging cable and charging plug 104, an electrical circuit 106, an electrical circuit sharing controller (ECSC) 108, a hashed data conversion machine 110, an electric vehicle 112, a network 114, a computing device 116, and a server 118. The computing device 116 includes an information accessing module 120.

The charging station 102 may also be represented as an electric vehicle charging station, an electric vehicle charging machine, an outdoor machine, and the like. The charging station 102 may be operated at 220 to 240 volts AC, and the charging station 102 may include multiple modules (as shown in FIG. 1B) to perform various types of operations. The modules (as shown in FIG. 1B) may be installed outdoors in an IP66 Waterproof, Dustproof Thermoplastic ABS Junction Box, which is a wall or pedestal mounted. The IP66 characteristics for protection may include, but are not limited to, complete protection from dust, oil, and other non-corrosive material, complete protection from contact with enclosed equipment, complete protection from water, even from powerful jets of water, and the like. The charging station 102 includes a 220-240 volt electrical distribution panel, associated wiring harnesses to the various modules, a 12-volt fan system, and various ducts and vents to facilitate air movement into and out of the charging station 102.

The charging station 102 may be configured to facilitate network-based connectivity between the computing device 116 and the charging station 102 itself. For example, the charging station 102 may be designed to enable the computing device 116 to establish a connection with the charging station 102 over the network 114. The computing device 116 may include, but is not limited to, a personal mobile computing device such as a tablet computer, a laptop computer, a netbook computer, a smartphone, a server, and backend servers hosting the database, and other software, and the like. The network 114 may include, but is not limited to, an Ethernet, a wireless local area network (WLAN), a wide area network (WAN), a Bluetooth low energy network, a ZigBee network, a Controller Area Network (CAN bus), a WIFI communication network, e.g., the wireless high-speed internet, or a combination of networks, a cellular service such as a 4G (e.g., LTE, mobile WiMAX) or 5G cellular data service, a RFID module, a NFC module, wired cables, such as the world-wide-web based internet, or other types of networks may include Transport Control Protocol/Internet Protocol (TCP/IP) or device addresses (e.g., network-based MAC addresses or those provided in a proprietary networking protocol, such as Modbus TCP, or by using appropriate data feeds to obtain data from various web services, including retrieving XML data from an HTTP address, then traversing the XML for a particular node) and the like without limiting the scope of the present disclosure.

The computing device 116 may be operated by a user. The user may include, but is not limited to, a vehicle driver, a vehicle owner, an individual, a customer, a miner, and the like. The computing device 116 may include the information accessing module 120 and is configured to provide charging information of the charging station 102 over the network 114. The charging information may include, but is not limited to, the cost of charging at each charging station, the hours of operation of the electric vehicle, any additional fees that may be implemented by the charging station owner, the type of charging connector available at the charging station, and the like. In addition, the information accessing module may be configured to enable the user to access the electric vehicle charging information on the computing device 116. For example, the information accessing module 120 on the computing device 116 may be configured to connect to the charging station 102 through wireless, cellular, or other means to access the charging information about the location of the charging station 102.

The charging station 102 includes the electrical circuit 106 and may be designed to supply electric power to the electric charger 104 of the charging station 102 in accordance with the relevant local building codes. The electric power may be represented as electric current, electric amperage, electric energy, and the like. It is possible to have multiple electric chargers in the charging station 102 (the electric vehicle charging stations) that are connected to the same electrical circuit 106, which is in turn connected to an electrical breaker panel that is fed by a service drop from a local utility distribution transformer or a power grid (132, as shown in FIG. 1C). The charging station 102 may be configured to deliver electric power to a battery of electric vehicle 112 through the electric charger 104 to charge the battery in a coupled configuration, and the charging station 102 does not charge the battery of the electric vehicle 112 when the electric charger 104 of the charging station is in an uncoupled configuration and routes/redirects/shares the electric power to a co-located machine, such as a hashed data conversion machine (e.g., the hashed data conversion machine 110). The hashed data conversion machine may execute blockchain calculations, such as mining digital currency. The digital currency may include, but is not limited to, Cryptocurrency, Bitcoins, Ethereum, XCF, Dogecoin, Cardano, and the like. The co-located machine may be configured to generate the digital currency outside of the typical air-conditioned environment (e.g., in an outdoor setting).

The maximum amount of electric current supported by the electrical circuit 106 is shared by the hashed data conversion machine 110 (e.g., cryptocurrency extraction hardware and software) and the electric charger 104 of the charging station 102. The excess electrical capability above charging station 102 demand is diverted to the hashed data conversion machine 110 by the electrical circuit sharing controller 108. In addition, the hashed data conversion machine 110 may be configured to use software and hardware to solve blockchain calculations, possibly resulting in the generation of digital cryptocurrency values.

The hashed data conversion machine 110 can generate digital currency via a processor (CPU), computer motherboard, Random Access Memory, Solid State hard drives, Graphics Processing Units, server-based components, power supplies, a computer-readable medium (Hard drive) connected to the processor, and a set of instructions on the computer-readable medium that are executable by the processor. The set of instructions on the computer-readable medium that are executable by the processor to receive an indication of an electrical load on the electrical circuit, may determine that the electrical load is below a charging threshold, and the like. The hashed data conversion machine 110 may be configured to integrate an Industry Standard computer Operating System (OS) and digital currency mining software (e.g., a hashed data conversion module).

The set of instructions (software) verifies and timestamps transactions into a shared public database called a “blockchain”. A miner (e.g., user) may rewarded with transaction fees and newly minted cryptocurrency for the work done to solve the equation. The hashed data conversion machine 110 is a specialized computer that can append blocks of transactions to the blockchain via the network 114. The hashed data conversion machine 110 may additionally or alternatively act as a transaction interface for transactions (e.g., a point of sale system) (as shown in FIG. 1B) for the charging station 102 via the network 114. The software set of instructions directs the hashed data conversion machine 110 to solve the equations at the time. Any derived digital currency can be stored in a digital wallet. The hashed data conversion machine 110 can be configured to engage in cloud computing, matchmaking, and aggregation services through, for example, Secure Shell Protocols.

The total amount of electric power available to the electrical circuit 106 may be based on attributes that relate to electric vehicle charging session duration, method of payment account associated with that charging session, percentage of charging complete, battery temperature of the electric vehicle, and/or time remaining on that charging session. The excess electric power beyond the requirement of the electric charger 104 may be routed to the hashed data conversion machine 110. For example, a 60 amp electrical circuit with a single 32 amp electric vehicle charger would have 28 amps available for the hashed data conversion machine 110 to access.

The electrical circuit sharing controller 108 may include computer-based hardware and software that transmits message packets to the charging station 102. The message packets may include the amount of electric power required for the electric charger 104 of the charging station 102. The message packets transmitted by the electrical circuit sharing controller 108 may be configured to instruct the electric charger 104 of the charging station 102 to utilize a certain amount of electric power they are able to draw from the electrical circuit 106. The electrical circuit sharing controller 108 may be configured to instruct the electric charger 104 of the charging station 102 to start or stop the flow of electric power on the electrical circuit 106 based on the message packets received from the control modules/server linked to the transaction interface authorization via internet, cellular, satellite, or Wide Area Network (WAN) 114.

The electrical circuit sharing controller 108 may be configured to receive acknowledgment messages from the electric charger 104 of the charging station 102. The acknowledgment messages from the electric charger 104 may indicate that the message packets transmitted by the electrical circuit sharing controller 108 were received by the charging station 102 and acted upon in accordance with the transmitted message packets to effect the charging of the electric vehicle. The electrical circuit sharing controller 108 may be configured to direct the excess electric power not used by the charging station 102 on the electrical circuit 106 to the co-located computer (hashed data conversion machine 110) based on the hardware and software applications in the hashed data conversion machine, thereby facilitating cryptocurrency/Blockchain processing.

The hashed data conversion machine 110, various sized and capable electric vehicle charging stations, the electrical circuit sharing controller, and different control modules include the computer-based hardware and software mine cryptocurrency, conduct Point of Sale processes if required, and send message signals for power regulation to the electrical circuit, and provide output to an LCD (EVTV).

In some embodiments, the hashed data conversion machine 110 can include one or more computation engines that can deploy computation-intensive services. For example, the hashed data conversion machine 110 can include an artificial intelligence module for executing artificial intelligence services to remote users. As noted above, the hashed data conversion machine 110 can include one or more shell protocols that may additionally or alternatively be able to perform human-like analysis using, for example, trained models, language generation, such as via large language models (LLMs),

Similar to the GPU based “miners” that solve various algorithms like SHA-256 and Scrypt, the hashed data conversion machine 110 may execute algorithms such as Pytorch, HashCat CUDA, Tensorflow, and Pygmillion AI. The system 100 can include a web search interface that allows users to quickly find the artificial intelligence services needed for their specific requirements.

The servers used by the system 100 to run the artificial intelligence services can be multi-GPU computers that have similar size, shape, and power requirements of the crypto-mining functionality of the hashed data conversion machine 110 described herein. The hashed data conversion machine 110 can include special-purpose A.I. servers that communicate with services like VAST AI to provide on-demand compute power.

The hashed data conversion machine 110 can include one or more of machine learning models to conduct inference, natural language processing (NLP), computer vision, speech recognition and synthesis, and/or recommendation systems.

The hashed data conversion machine 110 can include one or more high-performance CPUs and/or GPUs to, for example, process multiple tasks in parallel, which can be a common in AI workloads. Additionally or alternatively, the hashed data conversion machine 110 can include one or more hardware accelerators, such as tensor processing units (TPUs), field-programmable gate arrays (FPGAs), and/or application-specific integrated circuits (ASICs) to reduce power consumption and improve computation speed.

The system 100 can implement the artificial intelligence services via a cloud-based Infrastructure-as-a-Service (IaaS), which can provide virtualized computing resources (e.g., virtual machines, GPU instances) to host AI workloads, as a Platform-as-a-Service (PaaS) to provide pre-configured environments and frameworks for developing, training, and deploying the AI model output.

FIG. 1B is an example diagram 100b depicting the charging station, in accordance with one or more exemplary embodiments. For example, the diagram 100b depicts the charging station 102, the electric charger 104, the electrical circuit 106, the electrical circuit sharing controller (ECSC) 108, the hashed data conversion machine 110, a transaction interface 122, a status manager 124, a display 126, a display interface 128, and a network interface 130.

The charging station 102 (for example, the electric vehicle charging station) may include one or more charging levels, based on the user's requirements. The charging levels may include, but are not limited to, a first-level charging station may be used at a single-family residence, second-level charging station may be used at Multi-Family residential units and commercial workplaces, and a third-level charging station can include a rapid charging station, which may be located near interstate highways and industrial settings, and the like.

The electric charger 104 may be an electrical charging interface configured to couple to a corresponding receiving interface of the electric vehicle 112. For example, the electric charger 104 may be a J1772 charging plug. The electrical circuit 106 may be designed to supply electric power to the electric charger 104 of the charging station 102 in accordance with the relevant local building codes. It is possible to have multiple electric chargers for the charging station 102 (e.g., the electric vehicle charging stations) connected to the same electrical circuit 106, which is in turn connected to an electrical breaker panel that is fed by a service drop from a local utility distribution transformer or a power grid 132 (as shown in FIG. 1C).

The total amount of electric power available to the electrical circuit 106 may be based on the attributes which may relate to electric vehicle charging session duration, method of payment account associated with that charging session, percentage of charging complete, battery temperature of the electric vehicle, and/or time remaining on that charging session. The excess electric power beyond the requirement of the electric charger 104 of the charging station 102 can be routed to the hashed data conversion machine 110. For example, a 60 amp electrical circuit with a single 32 amp electric vehicle charger would have 28 amps available for the hashed data conversion machine 110 to access.

The electrical circuit sharing controller 108 may include computer-based hardware and software that transmit message packets to the charging station 102. The message packets transmitted by the electrical circuit sharing controller 108 may be configured to instruct the electric charger 104 of the charging station 102 to utilize a certain amount of electric power they are able to draw from the electrical circuit 106. The electrical circuit sharing controller 108 may be configured to instruct the electric charger 104 of the charging station 102 to start or stop the flow of electric power on the electrical circuit 106 based on the message packets received from the control modules or the server 118 linked to the transaction interface 122 authorization via the internet, cellular, satellite, and/or Wide Area Network (WAN) 114.

The electrical circuit sharing controller 108 may be configured to receive acknowledgment messages from the charging station 102. The acknowledgment messages may indicate that the message packets transmitted by the electrical circuit sharing controller 108 were received by the charging station 102 and acted upon in accordance with the transmitted message packets to affect the charging of the electric vehicle 112. In addition, the electrical circuit sharing controller 108 may be configured to direct the excess electric power not used by the charging station 102 on the electrical circuit 106 to the co-located computer (e.g., hashed data conversion machine 110) based hardware and software applications, thereby facilitating hashed data conversion (e.g., cryptocurrency/Blockchain processing).

The hashed data conversion machine 110 or another miner computer system can be equipped with a central processing unit (CPU) and/or a graphics processing unit (GPU) that facilitates the conversion of hashed data strings. Additionally or alternatively, the hashed data conversion machine 110 can include a plurality of GPUs or one or more special purpose processors that are configured for converting the hashed data strings. The special purpose processors can include processors that utilize parallel computing processes, which can more efficiently execute complex matrix calculations, including the kinds of calculations that may be used to convert hashed data strings or other bit streams. The hashed data conversion machine 110 can include a computer motherboard, Random Access Memory, Solid State hard drives, Graphics Processing Units, server-based components, power supplies, a computer-readable medium (Hard drive) connected to the processor, and a set of instructions on the computer-readable medium that are executable by the processor. The hashed data conversion machine 110 may be configured to integrate an Industry Standard computer Operating System (OS) and digital currency mining software (e.g., a hashed data conversion module). For example, the hashed data conversion machine 110 may be a computer-based cryptocurrency mining machine that uses Graphics processing units (GPUs) to solve blockchain transactions (e.g., to generate cryptocurrency). The charging station 102 can include a 12-volt fan system, and various ducts and vents to facilitate air movement into and out of the charging station 102.

The set of instructions can verify transactions and timestamp them in a shared public database called a “blockchain”. A blockchain verifier or miner (e.g., user 134) may be rewarded with transaction fees and newly minted cryptocurrency for the work done to solve the equation. The hashed data conversion machine 110 is a specialized computer that appends blocks of transactions to the blockchain via the network 114.

In some embodiments, the electrical circuit sharing controller 108 may be a power switching unit (PSU) configured to determine the electrical demand on the electric charger 104 of the charging station 102 for charging the battery of the electric vehicle 112 and allocates the excess electric power to the hashed data conversion machine 110 (For example, cryptocurrency mining rig). The hashed data conversion machine 110 may additionally act as the transaction interface 122 for the charging station 102 via the network 114. The software set of instructions directs the hashed data conversion machine 110 to solve the most profitable equation at the time. The derived digital currency may be stored in a digital wallet.

The transaction interface 122 may be configured to determine whether the user is authorized to charge the vehicle. The transaction interface 122 may be programmed with a set of software controls that may accept credit/debit card-style inputs transmitted via wired or wireless Internet systems. In some embodiments, the transaction interface 122 includes a point of sale (POS) system. The user may either pay for the charging session using a user card, a personal credit card at the charging station 102, and/or via the information accessing module 120 on the computing device 116.

Authorization to charge the electric vehicle 112 may be provided via co-located with the hashed data conversion machine 110 that does the mining. The hashed data conversion machine 110 may include Personal Computer (PC) components such as motherboard, power supplies, CPU, RAM, Hard Drives, GPU, and Internet connectivity devices. The transaction interface 122 may be configured to receive signals from the server 118, which contains a database of authorized users and authenticates the user, to allow the power switching unit to open the electrical circuit 106 and direct the electric power to the electric charger 104 of the charging station 102 to charge the battery of the electric vehicle 112.

The status manager 124 may be configured to deliver charging information to the computing device 116 over the network 114. The charging information may include, but is not limited to, the cost of charging at each charging station, the hours of operation of the vehicle, any additional fees that may be implemented by the charging station owner, the type of charging connector available at the station, and the like. In addition, the status manager 124 may be configured to provide the charging information on the computing device 116 over the network 114. For example, the charging station 102 may include the status manager 124 and may be configured to connect to the computing device 116 through wireless, cellular, or other means to provide charging information about the location of the charging station 102. In some embodiments, the status manager 124 includes a downloaded set of software instructions that the computing device 116 can execute. For example, the status manager 124 may include an application for a smartphone.

The display 126 may be configured to enable the user to interact with charging station 102 as it displays specific charging statistics. The display 126 may include an LCD display or some other type of display. The charging statistics may include but are not limited to, real-time current draw, voltage, power consumed, charging time, temperature, connection status, authentication status, and the like. The display interface 128 may be configured to enable the user to interact with the charging station 102 and expedite the authentication. The display interface 128 may operate via a Secure Socket Layer 128-bit encryption to protect the transaction. The display interface 128 may additionally or alternatively display Electric Vehicle TV (EVTV), a proprietary informational and entertainment service for the user to use while charging. The EVTV may provide relevant information to the user while the user waits for the vehicle 112 to be charged.

The network interface 130 may include, but is not limited to, wired and/or wireless interface. The network interface 130 can provide access to a network (e.g., internet, home network, etc.) and may be any of a wide variety of various wire or wireless interface components, such as an Ethernet card or interface module, a modem, a Bluetooth module, a cable modem, and the like without limiting the scope of the present disclosure. The charging station 102 may be connected to the computing device 116 over the network interface 130 and enable the user to operate the charging station 102 or to access the charging information on the computing device 116.

FIG. 1C is another example system 100c for charging electric vehicles and redirecting excess electric power to hashed data conversion machines, in accordance with one or more exemplary embodiments. The system 100c can include the charging station 102, the electric charger 104, the electrical circuit 106, the network 114, the computing device 116, the display 126, the network interface 130, the server 118, a power grid 132, and a user 134.

The electric charger 104 of the charging station 102 may share the electrical circuit 106 with the other electric chargers of the charging station 102, which are allocated some amount of the total electric current available on the electrical circuit 106. The charging station 102 may be configured to deliver the electric power to the battery of electric vehicle 112 when the electric charger 104 of the charging station 102 is in a coupled configuration. The charging station 102 may be configured not to charge the battery of the electric vehicle 112 when the electric charger 104 of the charging station 102 is in an uncoupled configuration and instead route/redirect/share the electric power to a co-located machine (e.g., the hashed data conversion machine 110) that mines the digital currency.

The charging station 102 may be configured to facilitate network-based connectivity between the computing device 116, and the charging station 102 itself. The charging station 102 can be configured to enable the computing device 116 to establish a connection with the charging station 102 over the network 114. The display 126 may be configured to allow the user 134 to interact with the charging station 102 as it displays specific charging statistics. The charging statistics may include but are not limited to, real-time current draw, voltage, power consumed, charging time, temperature, connection status, authentication status, and the like. The charging station 102 may be connected to the computing device 116 over the network interface 130 and enable the user 134 to operate the charging station 102 or to access the charging information on the computing device 116. The power grid 132 may be configured to deliver the electric power to the charging station 102. The electric charger 104, or multiple electric chargers of the charging station 102 may be on the same electrical circuit 106, which can be connected to an electrical breaker panel that is fed by a service drop from the local utility distribution transformer or the power grid 132.

FIG. 1D is another example block diagram 100d depicting the integrated electric charging system for charging electric vehicles and redirecting excess electric power to hashed data conversion machines, in accordance with one or more exemplary embodiments. The diagram 100d depicts the charging station 102, the electric charger 104, the electrical circuit sharing controller 108, the electric vehicle 112, the network 114, the computing device 116, the display 126, the hashed data conversion machine 110, the transaction interface 122, the power grid 132, the user 134, and a digital wallet 136.

The electrical circuit sharing controller 108 may be configured to receive a message packet from the electric charger 104 of the charging station 102 that indicates a request for an allocation of electric power. The charging station 102 may be configured to share the electrical circuit 106 with the other electric chargers of the charging station 102, which are allocated an amount of the total electric power available on the electrical circuit 106. The electrical circuit sharing controller 108 may be configured to determine whether granting the electric charger 104 requests of the charging station 102 would exceed a maximum amount of electric power supported by the electrical circuit 106 and decides to adjust the allocation of the electric power to the other electric chargers of the charging station 102 on the electrical circuit 106, such that the electrical circuit sharing controller 108 may be configured to allocate the electric power to the requested electric charger 104 of the charging station 102 for some amount of time.

The electrical circuit sharing controller 108 may be configured to limit the maximum amount of electric power supported by the electrical circuit 106 and ensures it is not exceeded. The message packets may include the amount of electric power required for the electric charger 104 of the charging station 102. The electrical circuit sharing controller 108 may be configured to transmit the message packets to the other electric chargers of the charging station 102 on the electrical circuit 106 to instruct the other electric chargers to reduce the amount of electric power drawn on the electrical circuit 106. Upon receiving a message from the electrical circuit sharing controller 108 from one of the electric charger(s) 104 indicating that the allocation the electric power is no longer required, the electrical circuit sharing controller 108 can redistribute the available electric power to the cryptocurrency hardware or one or more electric chargers to use.

The charging station 102 includes a computer-based hashed data conversion (e.g., blockchain execution, cryptocurrency mining) module coupled with multiple electric chargers 104, and the electrical circuit sharing controller (ECSC) 108 that all share the same electrical circuit 106. The charging station 102 includes the display 126 to provide visual confirmation to the user 134. The display 126 may also provide entertainment and advertising in the form of the Electric Vehicle Television (EVTV).

Various control modules in the charging station control the allocation of electric power to the electric chargers of the charging station 102 through one or more message packets to adjust the electric power allocation required based on the total amount of electric power allocated for the entire electrical circuit 106. The control modules may be configured to receive the electric power allocation requests from the hashed data conversion machine 110 and the electric charger of the charging stations. The control modules may be configured to transmit messages to the electric charger 104 of the charging station 102 that indicate an amount of electric power allocated to the electric charger 104. The control modules can instruct the charging station 102 to commence or cease drawing electric energy as required by the electric charger 104 via the set of instructions from the transaction interface 122.

The hashed data conversion machine 110 can additionally support a point of sale system (e.g., the transaction interface 122) for the charging station 102 via the network 114. The software set of instructions directs the hashed data conversion machine 110 to solve blockchain or other hashed data equations. The hashed data conversion machine 110 may be configured to generate the digital currency, and the generated digital currency may be stored in a digital wallet 136.

FIG. 1E is an example block diagram of a system 100e including a hashed data conversion machine 138, in accordance with one or more exemplary embodiments. The diagram 100e depicts the hashed data conversion machine 110, the network 114, and the computing device 116. The hashed data conversion machine 110 can include a hashed data conversion module 138. The hashed data conversion module 138 may be configured to verify and timestamp transactions into the shared public database (e.g., the “blockchain”. The hashed data conversion module 138 may be configured for mining the Ethereum Blockchain (ETH) with payment in Bitcoin (BTC) to a corporate digital wallet. The hashed data conversion module 138 may be configured to solve blockchain calculations resulting in the generation of digital cryptocurrency values. The computing device 116 includes the information accessing module 120 may be configured to interact with the charging station 102 through wireless, cellular, or other means to access the charging information about the location of the charging station 102.

FIG. 1F is another block diagram showing a system 100f that includes the charging station 102 and the computing device 116, in accordance with one or more exemplary embodiments. The charging station 102 includes an information providing module 125. The computing device 116 includes the information accessing module 120. The term “module” is used broadly herein and generally refers to a program resident in the memory of the computing device 116, the charging station 102 and/or the hashed data conversion machine 110, any of which may also include corresponding specialized hardware and/or firmware. The information accessing module 120 can include a user authentication module 140, a payment processing module 142, a location identifying module 144, a digital currency monitoring module 146, and/or a bus 154b. The bus 154b may include a path that permits communication among the sub-modules of the information accessing module 120.

The user authentication module 140 may be configured to enable the user 134 to authorize a verification signal received from the charging station to connect the computing device with the charging station 102 over the network 114. The payment processing module 142 may be configured to enable the user 134 to perform the payment transactions for charging the electric vehicle 112 at the charging station 102. The location identifying module 144 may be configured to allow the user 134 to identify a nearby location of the charging station 102 on the computing device 116. The digital currency monitoring module 146 may be configured to enable the user 134 to check the digital wallet 136 of the user's registered account.

The information providing module 125 includes an electric charging interface recommending module 148, hours of operation calculating module 150, and charging cost calculating module 152, and a bus 154a. The electric charging interface recommending module 148 may be configured to recommend the type of chargers available at the charging station 102 and enables the user 134 to check on the computing device 116 over the network 114. The operation calculating module 150 may be configured to calculate the time charged by the electric vehicle 112 at the charging station 102.

The charging cost calculating module 152 may be calculated based on the hours of operation of the charging station 102 to charge the electric vehicle 112 and enables the user 134 to check on the computing device 116 over the network 114. The bus 154a may include a path that permits communication among the sub-modules of the information providing module 125.

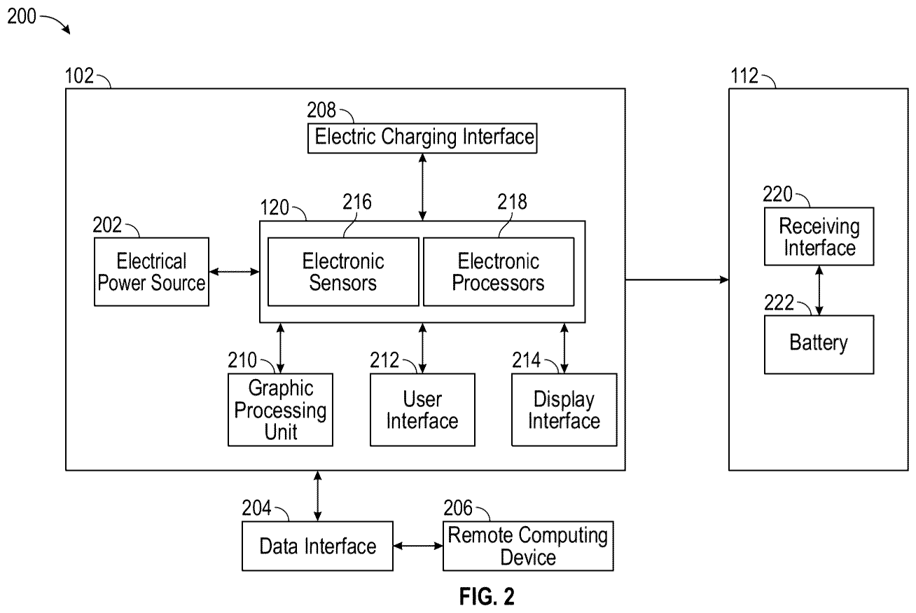

FIG. 2 is a block diagram 200 depicting a system 200 in which aspects of the present disclosure can be implemented. FIG. 2 shows a schematic representation of an electrical energy redirection system, in accordance with one or more exemplary embodiments. The system 200 includes an electrical power source 202, a data interface 204, a remote computing device 206, the charging station 102, and/or the electric vehicle 112. The charging station 102 includes an electric charging interface 208, a graphics processing unit 210, a user interface 212, a display interface 214, and the power switching unit or the electrical circuit sharing controller 108. The power switching unit or the electrical circuit sharing controller 108 includes an electronic sensor 216, and an electronic processor 218. The electric vehicle 112 includes a receiving interface 220, and a battery 222. The charging station 102 may include air vents or cooling vents.

The electrical charging interface 208 may be configured to couple to the corresponding receiving interface 220 of the electric vehicle 112 outdoors. The electrical charging interface 208 may be represented as the electric charger 104. The electrical charging interface 208 may be configured to charge the battery 222 of the electric vehicle 112 in a coupled configuration. In an uncoupled configuration, the electrical charging interface 208 may not direct the electrical energy to the receiving interface 220 of the electric vehicle 112.

The data interface 204 may be configured to receive authorization from the remote computing device 206 for charging the battery 222 of the electric vehicle 112. The data interface 204 may be the network. The user interface 212 includes the display interface 214. The user interface 212 may be the information providing module 125 (e.g., as shown in FIG. 1F). The user interface 212 may be configured to receive user credentials through the display interface 214, and in response to receiving the user credentials, the data interface 204 may be configured to transmit a verification signal via the data interface 204 and to receive the authorization from the remote computing device 206. The customer or the user 134 may operate the remote computing device 206 or the computing device 116. The display interface 214 may be configured to receive the user selection and enable the electrical charging interface 208 to charge the battery 222 of the electric vehicle 112 in the coupled configuration. The display interface 214 may be the display 126 and/or the display interface 128.

The graphics processing unit 210 may be configured to receive a hashed data string with a fixed length and to determine an original data input therefrom. The graphics processing unit 210 may be the hashed data conversion machine. The power switching unit or the electrical circuit sharing controller 108 includes the electronic sensor 216 may be configured to identify when the electrical charging interface 208 is coupled to the corresponding receiving interface 220 for charging the battery 222 of the electric vehicle 112. The electronic processor 218 may be configured to execute instructions to receive an indication of an electrical load on the electrical charging interface 208 from the electronic sensor 216. The electronic processor 218 may determine that the electrical load is below a charging threshold and determine that the electrical load is above a charging threshold. The electronic processor 218 may be configured to redirect electric power from the electrical power source 202 to the graphics processing unit 210 instead of to the electrical charging interface 208 based on the determination that the electrical load is below a charging threshold, and transmit a signal to cause the graphics processing unit 210 to calculate the original data input from the hashed data string.

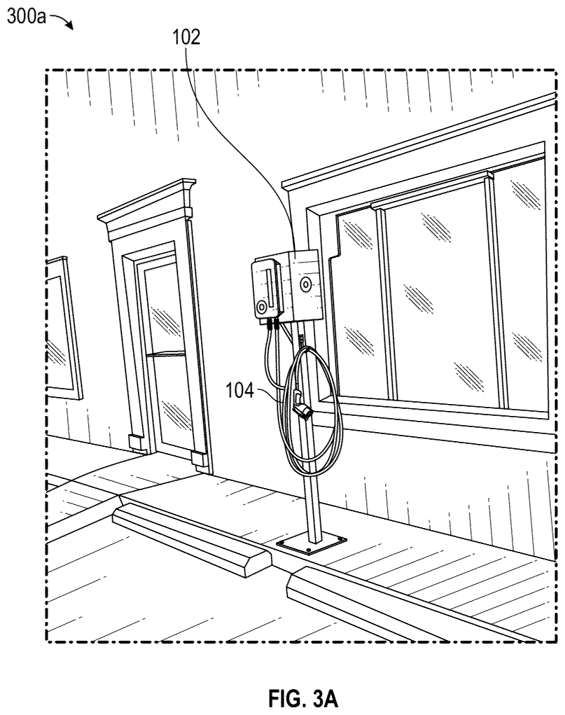

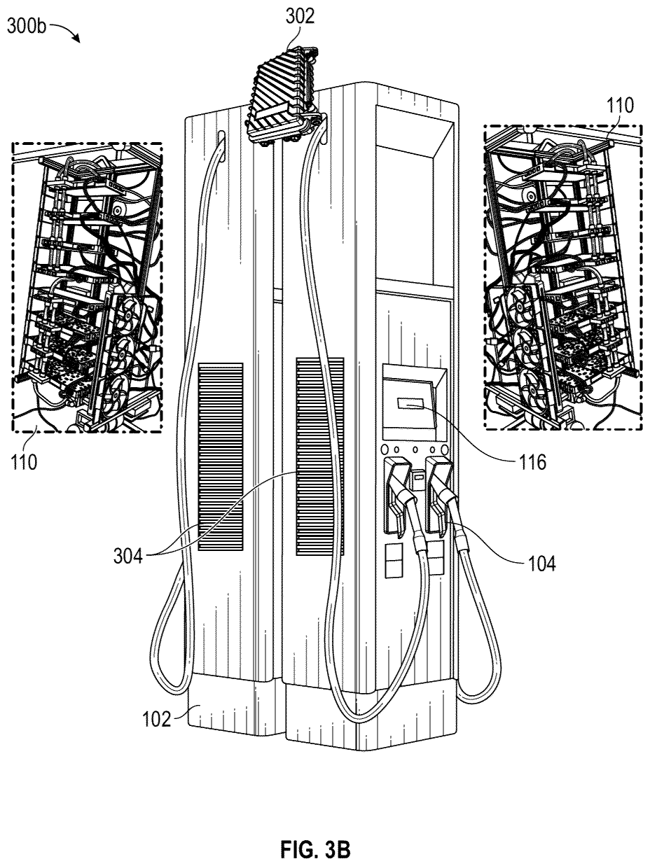

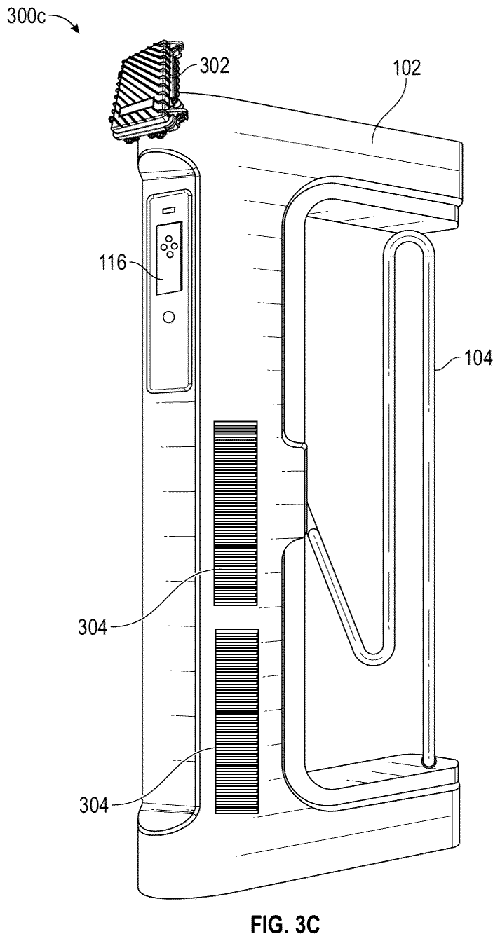

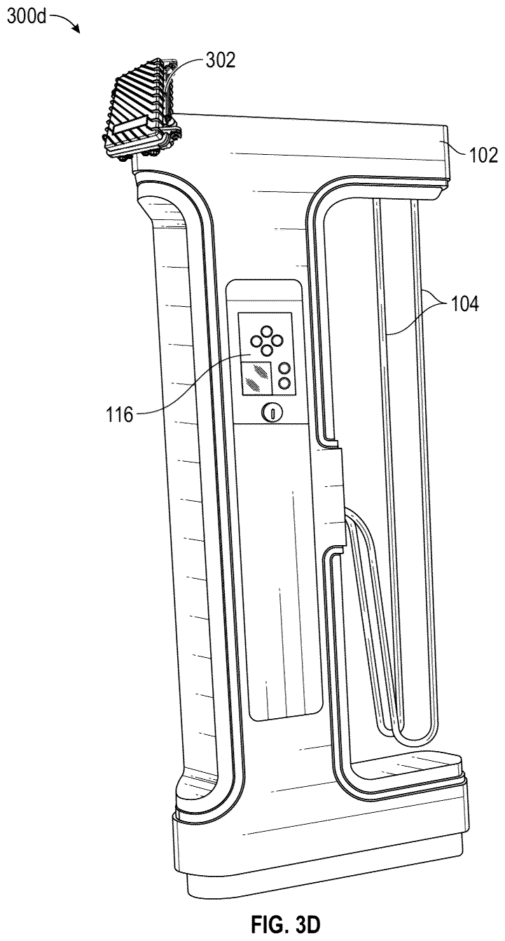

FIG. 3A is an example diagram 300a depicting a first-level integrated charging station, in accordance with one or more exemplary embodiments. The diagram 300a shows the first level charging station 102 includes the electric charger 104. The charging station 102 may be designed to be outdoors in various climates ranging from cold and snowy climates to deserts or mountains. The pedestal of the charging station 102 may acts as a heat discharge duct for the IP66 box. The prototype charging station 102 may be configured to perform said operations of charging and mining the Ethereum Blockchain (ETH) with payment in Bitcoin (BTC) to a corporate digital wallet.

FIG. 3B and FIG. 3C show example diagrams 300b, 300c depicting other example (e.g., second-level) charging stations with four chargers or two chargers, in accordance with one or more exemplary embodiments. The diagrams 300b and 300c depict each show a charging station 102 with a network hotspot 302 (e.g., a Helium Hotspot), air vents or cooling vents 304, the electric charger 104, and/or one or more hashed data conversion machines 110. The charging station 102 can allow, via the network hotspots 302, further versatility and connectivity via external mounting on the IP66 box. The charging station 102 may not require additional cooling as the network hotspot 302 can be designed as a natively outdoor device. Additionally or alternatively, external antennae can provide extended ranges of coverage. The network hotspot 302 can be included as part of a network that creates public, long-range wireless coverage for wide-area network (e.g., LoRaWAN) enabled Internet of Things devices. The network hotspot 302 can produce cryptocurrency, such as HNT, which is a native cryptocurrency of the Helium blockchain. The Helium blockchain is an open-source, public blockchain configured to develop physical, decentralized wireless networks. The Helium blockchain, and its hundreds of thousands of Hotspots, provide access to the largest LoRaWAN network in the world. For example, fleet vehicles could be easily tracked when in range of a Helium Hotspot. The diagrams 300b and 300c include a working prototype of a free-standing second-level charging station with IP66, 220 volts, 32 amp, and single phase unit capable of operating in temperatures from −40° F. to 130° F.

The network hotspot 302 can run on a 1*15 amp 110-volt circuit, and may use 5 watts. The server can run on a 2*20 amp 220-volt outlet, and use 1300 watts. The charging station 102 requires internet connection 1*RJ-45 CAT 5 Internet connection or 5G wireless connection over WAN. The hashed data conversion machine 110 may be mounted vertically or horizontally inside the charging station 102. The dimensions of the hashed data conversion machine 110 may include a length of about 78.5 cm or 30.91 inches, a width of about 51.5 cm or 20.28 inches, and a height of about 24.5 cm or 9.65 inches. The operating environment limitations of the hashed data conversion machine 110 may include, but is not limited to, a temperature of between about −10° C. (14° F.) to 42° C. (107.6° F.), a relative humidity (RH) of between about 5% and 95%. The system may be able to achieve this using an equivalent to a 4 inch inline fan to allow for 200 cubic feet per minute airflow/exchange, such as via the air vents 304.

The air vents 304 may be configured to prevent environmental debris from contacting the hashed data conversion machine 110. In addition, the air vents 304 may be configured to direct ambient outdoor air towards the hashed data conversion machine 110, thereby cooling the hashed data conversion machine 110. These air vents may be beneficial in extending the range of temperatures, humidity, and other factors in which the charging station and hashed data conversion machine 110 can operate.

FIG. 3D is a diagram 300d depicting another example (e.g., third-level) charging station, in accordance with one or more exemplary embodiments. The diagram 300d shows the charging station 102, the hashed data conversion machine 110, and the electric charger 104. The first level, the second level, and the third level charging stations are connected via a 220-volt circuit and operate in the 20 amp to 100 amp range. The digital currency generation (mining) capability and the electric charger 104 are coupled in one device (the electric vehicle (EV) charging station 102) via hardware and software controller systems and modules. Both capabilities may be wired on the same 220-volt electrical circuit. The hardware controllers implement a circuit-sharing process that dynamically allocates electric power to single or multiple electric chargers 104 of the charging station 102 on the same electrical circuit 106 such that the capacity of the electrical circuit 106 is not exceeded. For example, when the electric power demand for the charging station 102 is less than the peak demand energy, the excess electric power from the charging station 102 is apportioned to the hashed data conversion machine 110 to facilitate revenue generation via a computer-based hardware and software controller system.

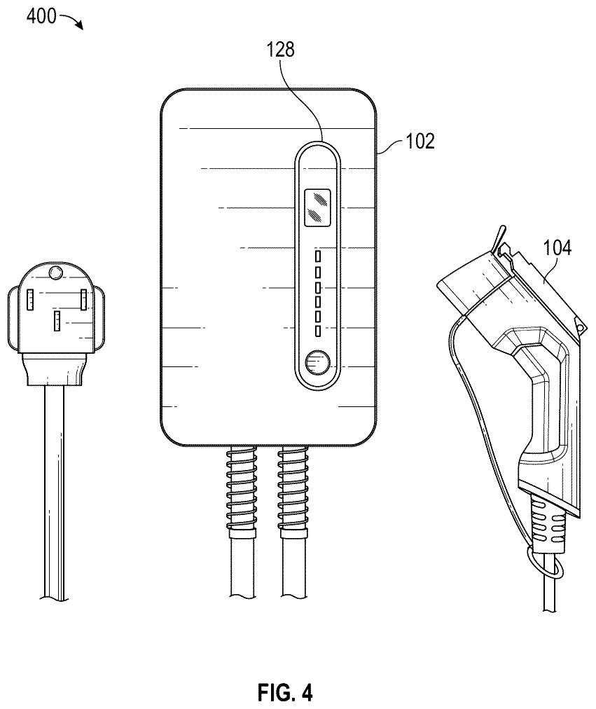

FIG. 4 is another diagram 400 depicting the electric charger or the charger cable and charging plug of the charging station, in accordance with one or more exemplary embodiments. The system 400 shows the electric charger or the charger cable and charging plug 104, the display interface 128, as part of the example charging station 102 shown. The charging station 102 shown in FIG. 4 may be particularly beneficial for residential settings, where approximately 84% of charging is done. The charging station 102 may be of 32 Amps, 240 V, 7.6 kW. The enclosure of the charging station 102 may be ABS plastic and is IP66 waterproof. The electric charger 104 may include a 25-foot extension cable and is suitable for any modern electric vehicle. The electric charger 104 may consist of a NEMA 14-50 32 Amp 250 v 4-prong plug. The LCD display 126 may display all the vehicle data on the charging station during charging. In addition, the LCD display 126 may display the state of the charge, including temperature, voltage, and current.

The charging station 102 may be a wall installation or a stand-alone station. The charging station may be voltage rated between about 100 V and about 250 V. The charging station may draw a current of about 32 Amp with a maximum power of about 7.68 kW. The charging station 102 may include a single phase station with an operating temperature of between about −40° C. and about 70° C. and a length of the cable of about 25 ft or about 7.6 m and diameter of the electric wire of about 2*8 mm²+1*6 mm².

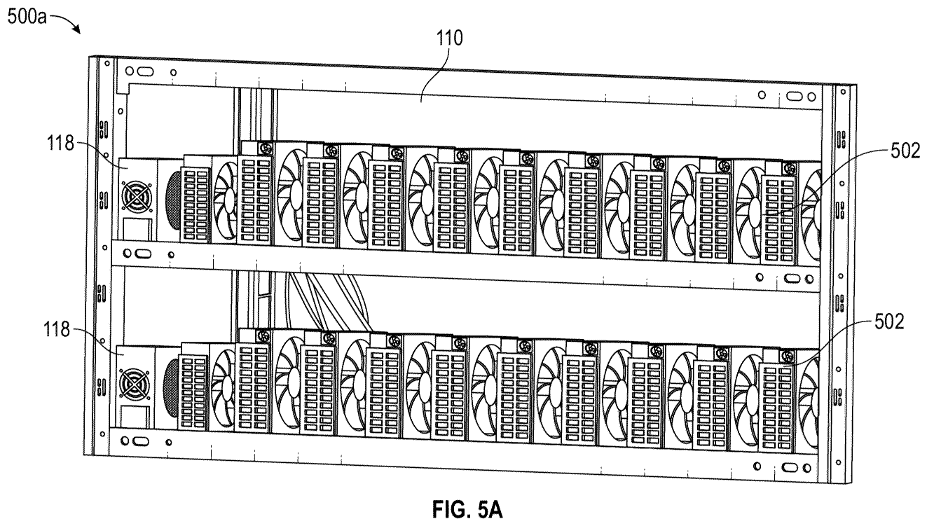

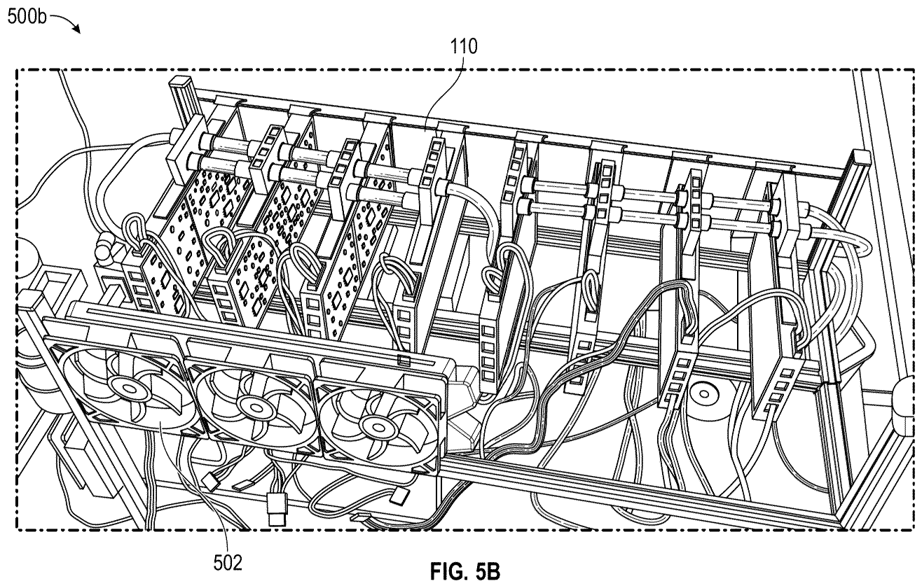

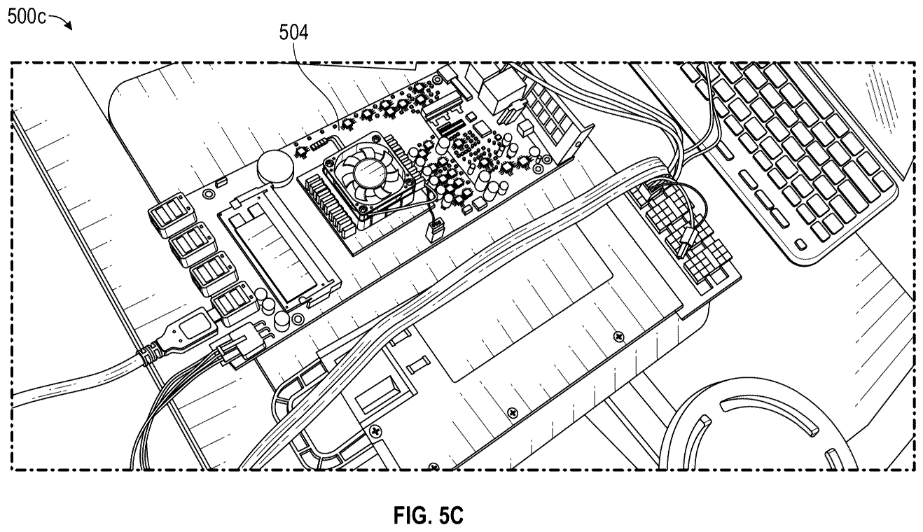

FIG. 5A, FIG. 5B show example diagrams 500a, 500b depicting the hashed data conversion machine of the charging station, in accordance with one or more exemplary embodiments. The diagram 500a, and 500b show the liquid-cooled hashed data conversion machine 110. The liquid-cooled hashed data conversion machine 110 can include multiple radiators and fans or a fan system 502. The fans 502 may be configured to move air through the enclosure of the charging station 102 and discharge the air through external ports and air vents 304. Air cooling via fans 502 and air vents 304 provides substantial cooling and is suitable in normal environmental conditions (less than 90° F.). In addition, the pedestal of the first level charging station 102 may act as a heat discharge duct for the IP66 box.

The hashed data conversion machine 110 may be a computer-based cryptocurrency mining machine that uses a Graphics processing unit (GPUs) or other special purpose processor to solve blockchain transactions. In environmental conditions more significant than 90° F., sustained operations may require additional methods to cool the hashed data conversion machine 110. The methods to cool the hashed data conversion machine 110 may include, water blocks, radiators, reservoirs, a pump, and/or an associated plumbing system to provide a liquid-cooled solution sufficient to 120° F. Additional cooling may also be derived from other energy sources include geothermal, solar, wind, and/or wave-powered alternative energy sources.

FIG. 5C is an example diagram 500c depicting a motherboard of the hashed data conversion machine, in accordance with one or more exemplary embodiments. The diagram 500c depicts a motherboard 504 of the hashed data conversion machine 110.

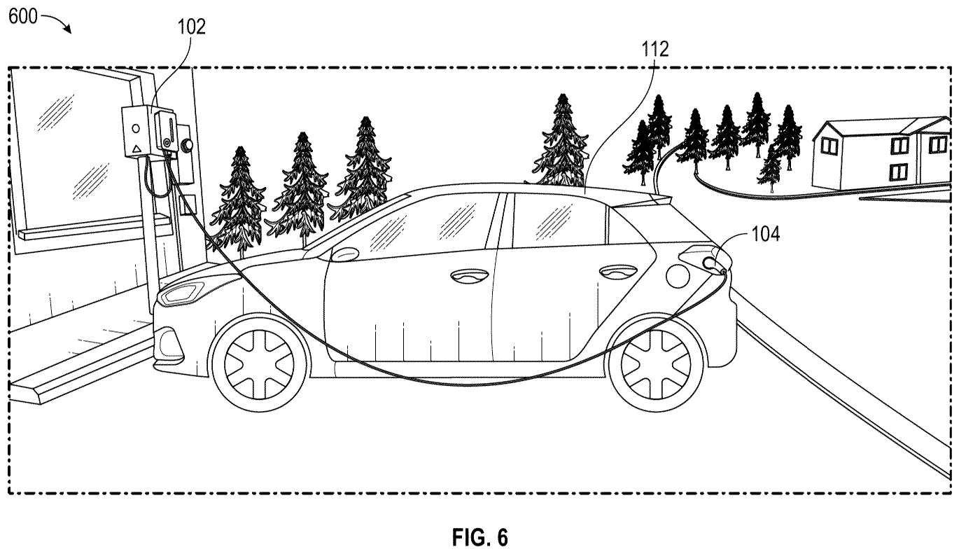

FIG. 6 is an example diagram 600 depicting another example charging station, in accordance with one or more exemplary embodiments. The diagram 600 includes the electric vehicle 112, and the charging station 102 in an outdoor setting. The diagram 600 depicts the charging station 102 charging the electric vehicle 112 of the user 134.

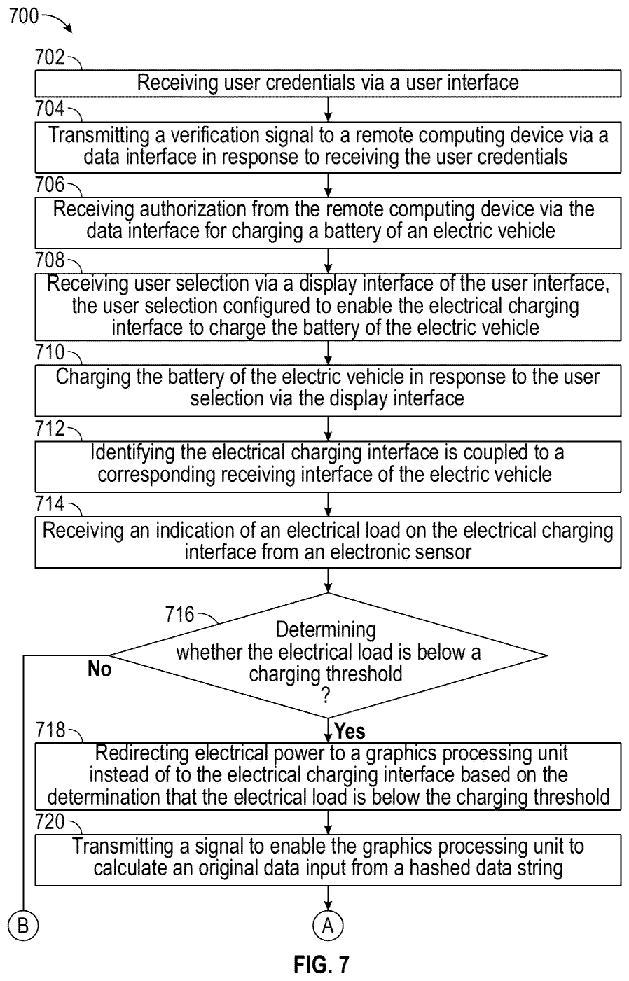

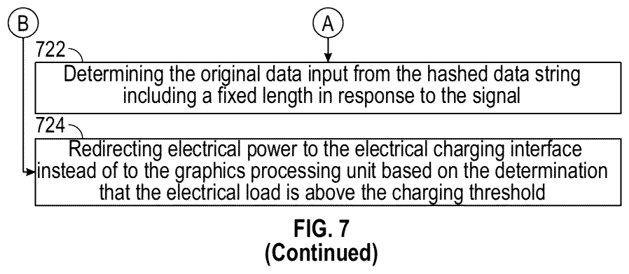

FIG. 7 is an example flow diagram 700 depicting a method for redirecting electric power from a graphics processing unit to an electrical charging interface, in accordance with one or more exemplary embodiments. The method 700 may be carried out in the context of the details of FIG. 1A, FIG. 1B, FIG. 1C, FIG. 1D, FIG. 1E, FIG. 1F, FIG. 2, FIG. 3A, FIG. 3B, FIG. 3C, FIG. 3D, FIG. 4, FIG. 5A, FIG. 5B, FIG. 5C, and/or FIG. 6 and may be carried out by any system described therein. However, the method 700 may also be carried out in another context. Further, the aforementioned definitions may equally apply to the description below.

The method 700, at step 702, includes receiving user credentials via a user interface. At step 704, the method 700 includes transmitting a verification signal to a remote computing device via a data interface in response to receiving the user credentials. At step 706, the method 700 includes receiving authorization from the remote computing device via the data interface for charging a battery of an electric vehicle. At step 708, the method 700 includes receiving user selection via a display interface of the user interface, the user selection configured to enable the electrical charging interface to charge the battery of the electric vehicle. At step 710, the method 700 includes charging the electric vehicle's battery in response to the user selection via the display interface. At step 712, the method 700 includes identifying that the electrical charging interface is coupled to a corresponding receiving interface of the electric vehicle. At step 714, the method 700 includes receiving an indication of an electrical load on the electrical charging interface from an electronic sensor. At step 716, the method 700 includes determining whether the electrical load is below a charging threshold. If the answer at step 716 is Yes, then at step 718, the method 700 includes redirecting electric power to a graphics processing unit instead of to the electrical charging interface based on the determination that the electrical load is below the charging threshold. At step 720, the method 700 includes transmitting a signal to enable the graphics processing unit to calculate an original data input from a hashed data string. At step 722, the method 700 includes determining the initial data input from the hashed data string, including a fixed length in response to the signal. If the answer at step 716 is No, then at step 724, the method 700 includes redirecting electric power to the electrical charging interface instead of to the graphics processing unit based on the determination that the electrical load is above the charging threshold.

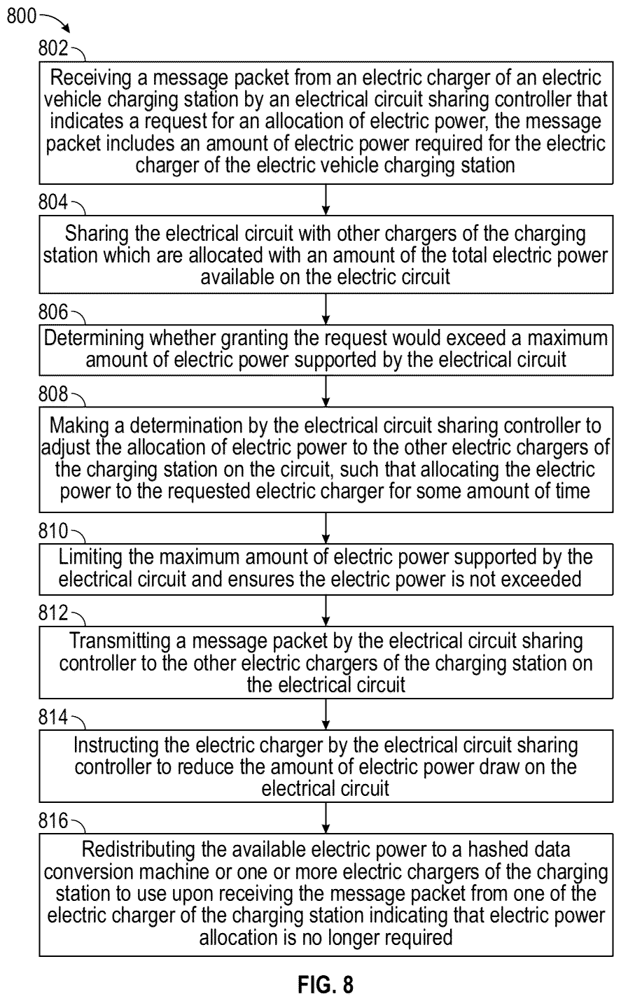

FIG. 8 is an example flow diagram 800 depicting a method for generating digital currency and charging electric vehicles, in accordance with one or more exemplary embodiments. The method 800 may be carried out in the context of the details of FIG. 1A, FIG. 1B, FIG. 1C, FIG. 1D, FIG. 1E, FIG. 1F, FIG. 2, FIG. 3A, FIG. 3B, FIG. 3C, FIG. 3D, FIG. 4, FIG. 5A, FIG. 5B, FIG. 5C, FIG. 6, and/or FIG. 7 and may be carried out by any system described therein. However, the method 800 may also be carried out in any other context. Further, the aforementioned definitions may equally apply to the description below.

The method 800 at step 802 includes receiving a message packet from an electric charger of an electric vehicle charging station by an electrical circuit sharing controller, which indicates a request for an allocation of electric power. The message packet includes the amount of electric power required for the electric charger of the electric vehicle charging station. At step 804, the method 800 includes sharing the electrical circuit with one or more other chargers of the charging station, which are allocated with an amount of the total electric power available on the electrical circuit. At step 806, the method 800 includes determining whether granting the request would exceed a maximum amount of electric power supported by the electrical circuit. At step 808, the method 800 includes making a determination by the electrical circuit sharing controller to adjust the allocation of electric power to the other electric chargers of the charging station on the circuit, such as allocating the electric power to the requested electric charger for some amount of time. At step 810, the method 800 includes limiting the maximum amount of electric power supported by the electrical circuit and ensures the electric power is not exceeded. At step 812, the method 800 includes transmitting a message packet by the electrical circuit sharing controller to the other electric chargers of the charging stations on the electrical circuit. At step 814, instructing the electric charger by the electrical circuit sharing controller to reduce the amount of electric power draw on the electrical circuit. At step 816, the method 800 includes redistributing the available electric power to the hashed data conversion machine or one or more electric chargers of the charging station to use upon receiving the message packet from one of the electric chargers of the charging station indicating that electric power allocation is no longer required.

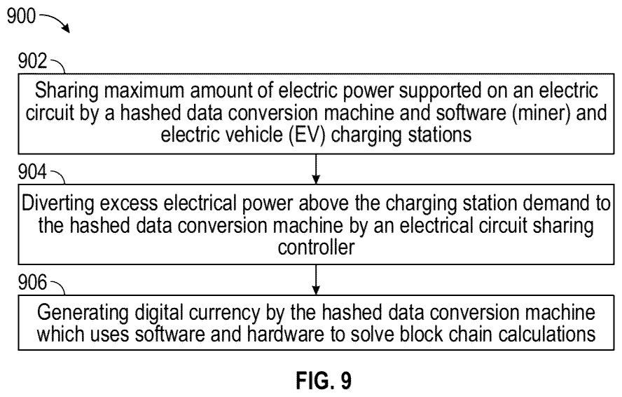

FIG. 9 is an example flow diagram 900 depicting a method for simultaneous hashed data conversion and charging electric vehicles, in accordance with one or more exemplary embodiments. The method 900 may be carried out in the context of the details of FIG. 1A, FIG. 1B, FIG. 1C, FIG. 1D, FIG. 1E, FIG. 1F, FIG. 2, FIG. 3A, FIG. 3B, FIG. 3C, FIG. 3D, FIG. 4, FIG. 5A, FIG. 5B, FIG. 5C, FIG. 6, FIG. 7, and/or FIG. 8 and may be carried out by any system described therein. However, the method 900 may also be carried out in any other context. Further, the aforementioned definitions may equally apply to the description below.

The method 900 At step 902, includes sharing the maximum amount of electric power supported on the electrical circuit by the hashed data conversion machine and software (miner) and electric vehicle (EV) charging stations. At step 904, the method 900 includes diverting the excess electric power above the charging station demand to a hashed data conversion machine by the electrical circuit sharing controller. At step 906, the method 900 includes generating digital currency by the hashed data conversion machine, which uses software and hardware to solve blockchain calculations.

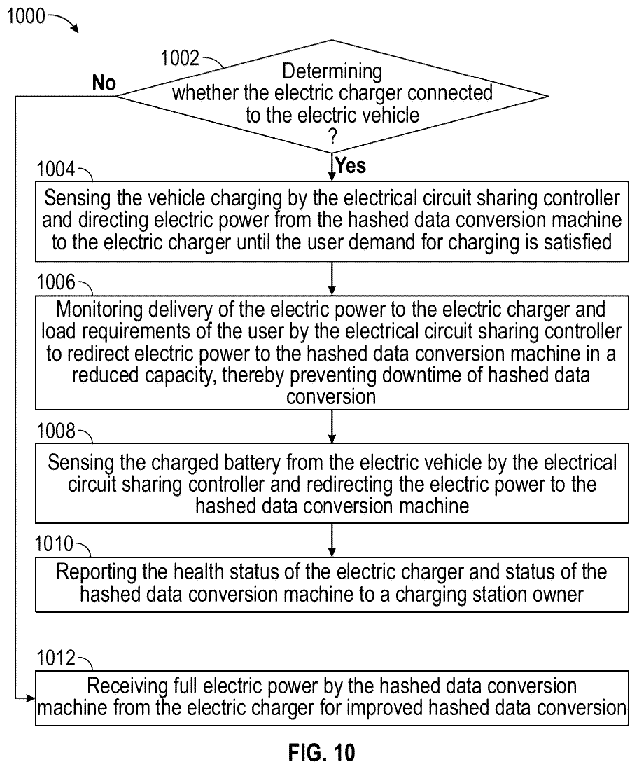

FIG. 10 is another example flow diagram 1000 depicting a method for simultaneous hashed data conversion and charging electric vehicles, in accordance with one or more exemplary embodiments. The method 1000 may be carried out in the context of the details of FIG. 1A, FIG. 1B, FIG. 1C, FIG. 1D, FIG. 1E, FIG. 1F, FIG. 2, FIG. 3A, FIG. 3B, FIG. 3C, FIG. 3D, FIG. 4, FIG. 5A, FIG. 5B, FIG. 5C, FIG. 6, FIG. 7, FIG. 8 and/or FIG. 9 and may be carried out by any system described therein. However, the method 1000 may also be carried out in any other context. Further, the aforementioned definitions may equally apply to the description below.

The method 1000 At step 1002 includes determining whether the electric charger is connected to the electric vehicle. If the answer at step 1002 is Yes, at step 1004, the method 1000 includes sensing the vehicle charging by the electrical circuit sharing controller and directing electric power from the hashed data conversion machine to the electric charger until the user demand for charging is satisfied. At step 1006, the method 1000 includes monitoring the delivery of the electric power to the electric charger and load requirements of the user by the electrical circuit sharing controller to redirect electric power to the hashed data conversion machine in a reduced capacity, thereby preventing downtime of hashed data conversion. At step 1008, the method 1000 includes sensing the charged battery from the electric vehicle by the electrical circuit sharing controller and redirecting the electric power to the hashed data conversion machine for continuous profit generation. At step 1010, the method 1000 includes reporting the health status of the electric charger and the status of the hashed data conversion machine to a charging station owner. If the answer at step 1002 is No, at step 1012, the method 1000 includes receiving full-electric power by the hashed data conversion machine from the electric charger for improved hashed data conversion.

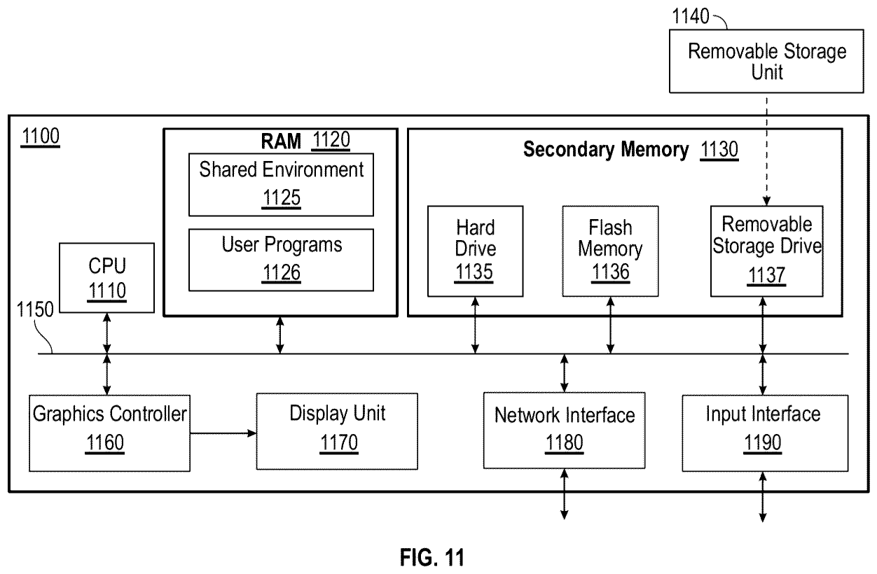

FIG. 11 is a block diagram 1100 illustrating the details of a digital processing system 1100 in which various aspects of the present disclosure are operative by execution of appropriate software instructions. The digital processing system 1100 may correspond to the computing device 116 and/or the hashed data conversion machine 110 (or any other system in which the various features disclosed above can be implemented).

The digital processing system 1100 may contain one or more processors such as a central processing unit (CPU) 1110, a random access memory (RAM) 1120, a secondary memory 1127, a graphics controller 1160, a display unit 1170, network interface 1180, and/or an input interface 1190. One or more of the components (e.g., except the display unit 1170) may communicate with each other over communication path 1150, which may contain several buses. The components of FIG. 11 are described below in further detail.

The CPU 1110 may execute instructions stored in the RAM 1120 to provide several features of the present disclosure. The CPU 1110 may contain multiple processing units, with each processing unit potentially being designed for a specific task. Alternatively, the CPU 1110 may contain only a single general-purpose processing unit.

The RAM 1120 may receive instructions from secondary memory 1130 using communication path 1150. The RAM 820 is shown currently containing software instructions, such as those used in threads and stacks, constituting a shared environment 1125 and/or user programs 1126. The shared environment 1125 includes operating systems, device drivers, virtual machines, etc., which provide a (common) run time environment for execution of user programs 1126.

The graphics controller 1160 generates display signals (e.g., in RGB format) to display unit 1170 based on data/instructions received from CPU 1110. Display unit 1170 contains a display screen to display the images defined by the display signals. Input interface 1190 may correspond to a keyboard and a pointing device (e.g., touch-pad, mouse) and may be used to provide inputs. Network interface 1180 provides connectivity to a network (e.g., using Internet Protocol), and may be used to communicate with other systems (such as those shown in FIG. 1A) connected to the network 114. The network interface 1180 may correspond to and/or include one or more features of the data interface 204.

A secondary memory 1130 may contain a hard drive 1135, a flash memory 1136, and a removable storage drive 1137. The secondary memory 1130 may store the data software instructions (e.g., for performing the actions noted above with respect to the Figures above), which enable digital processing system 1100 to provide several features in accordance with the present disclosure.

Some or all of the data and instructions may be provided on the removable storage unit 1140, and the data and instructions may be read and provided by removable storage drive 1137 to the CPU 1110. A floppy drive, magnetic tape drive, CD-ROM drive, DVD Drive, Flash memory, or other removable memory chip (PCMCIA Card, EEPROM) are examples of such removable storage drive 1137.

A removable storage unit 1140 may be implemented using medium and storage format compatible with the removable storage drive 1137 such that the removable storage drive 1137 can read the data and instructions. Thus, the removable storage unit 1140 can include a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 1140 or hard disk installed in hard drive 1135. These computer program products are means for providing software to digital processing system 1100. The CPU 1110 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as the storage memory 1130. Volatile media includes dynamic memory, such as RAM 1120. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media may be distinct from and/or may be used in conjunction with transmission media. Transmission media participates in transferring information between storage media. For example, transmission media includes coaxial cables, copper wire and fiber optics, including the wires that comprise bus (communication path) 1150. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

### EXAMPLE EMBODIMENTS

Some non-limiting example embodiments are provided below:

In a 1st Example, a system for charging electric vehicles and redirecting excess electric power to hashed data conversion machines comprising: an electric vehicle charging station comprising: an electrical power source; an electrical charging interface configured to couple to a corresponding receiving interface of an electric vehicle within the outdoors, wherein in a coupled configuration the electrical charging interface is configured to charge a battery of the electric vehicle and in an uncoupled configuration the electrical charging interface is configured not to direct electrical energy to the receiving interface of the electric vehicle; a data interface configured to receive authorization from a remote computing device for charging the battery of the electric vehicle; a user interface comprising a display interface, the user interface configured to: receive user credentials, wherein in response to receiving the user credentials, the data interface is configured to transmit a verification signal via the data interface and to receive the authorization from the remote computing device; and receive, via the display interface, user selection configured to cause the electrical charging interface to charge the battery of the electric vehicle in the coupled configuration; a graphics processing unit configured to receive a hashed data string having a fixed length and to determine an original data input therefrom; at least one air vent configured to prevent environmental debris from contacting the graphics processing unit and to direct ambient outdoor air and toward the graphics processing unit, thereby cooling the graphics processing unit; a power switching unit comprising: an electronic sensor configured to identify when the electrical charging interface is coupled to the corresponding receiving interface and charging the battery of the electric vehicle; and an electronic processor configured to execute instructions, wherein the electronic processor is configured to execute the instructions to at least: receive from the electronic sensor an indication of an electrical load on the electrical charging interface; determine that the electrical load is below a charging threshold; based on the determination that the electrical load is below a charging threshold, redirect electric power from the electrical power source to the graphics processing unit instead of to the electrical charging interface; and transmit a signal to cause the graphics processing unit to calculate the original data input from the hashed data string.

In a 2nd Example, the system of Example 1, wherein the graphics processing unit comprises a hashed data conversion module configured to solve block chain calculations.

In a 3rd Example, the system of Example 2, wherein the graphics processing unit comprises a fan system configured to move air through an enclosure of the electric vehicle charging station and discharge the air through the at least one air vent.

In a 4th Example, the system of Example 3, wherein the fan system is configured to allow operation of the graphics processing unit for an extended time in a temperature of up to 90° F.

In a 5th Example, the system of Example 4, wherein the electric power supported by the electrical power source is based on at least one of a duration of electric vehicle charging session, a method of payment account associated with that charging session, a percentage of charging complete, a battery temperature of the electric vehicle, or the time remaining on that charging session.

In a 6th Example, the system of Example 5, wherein the remote computing device comprises an information accessing module configured to enable the user to access charging information on the remote computing device.

In a 7th Example, the system of any of Examples 5-6, wherein the charging information comprises a number of hours of operation of the electric vehicle or a type of charging connector available at the electric vehicle charging station.

In a 8th Example, the system of Example 7, wherein the information accessing module comprises a user authentication module configured to enable the user to authorize the verification signal received from the electric vehicle charging station and to connect the remote computing device with the electric vehicle charging station over the data interface.

In a 9th Example, the system of Example 8, wherein the information accessing module comprises a payment processing module configured to enable the user to perform one or more payment transactions for charging the electric vehicle at the electric vehicle charging station.

In a 10th Example, the system of Example 9, wherein the information accessing module comprises a location identifying module configured to enable the user to identify a nearby location of one or more electric vehicle charging stations on the remote computing device via the data interface.

In a 11th Example, the system of Example 10, wherein the information accessing module comprises a digital currency monitoring module configured to enable the user to review or update a digital wallet associated with a user account.

In a 12th Example, the system of Example 11, wherein the user interface comprises an information providing module configured to provide charging information on the display interface of the electric vehicle charging station.

In a 13th Example, the system of Example 12, wherein the information providing module comprises an electric charging interface recommending module configured to recommend a type of electric chargers available at the electric vehicle charging station and to enable the user to check on the remote computing device over the data interface.

In a 14th Example, the system of Example 13, wherein the information providing module comprises an hours of operation calculating module configured to calculate a total amount of time charged to the electric vehicle.

In a 15th Example, the system of Example 14, wherein the information providing module comprises a charging cost calculating module configured to calculate a total cost based on the hours of operation of the electric vehicle charging station.

In a 16th Example, the system of Example 1-15, further comprising a network hotspot coupled to the charging station, the network hotspot configured to provide extended ranges of coverage by additional, and external antennae.

In a 17th Example, the system of any of Examples 1-16, wherein the display interface configured to enable the user to provide user input into the electric vehicle charging station to authenticate user credentials.

In a 18th Example, a method for redirecting electric power from a graphics processing unit to an electrical charging interface, the method comprising receiving, via a user interface, user credentials; in response to receiving the user credentials, transmitting, via a data interface, a verification signal to a remote computing device; receiving, via the data interface, authorization from the remote computing device for charging a battery of an electric vehicle; receiving, via a display interface of the user interface, user selection configured to cause the electrical charging interface to charge the battery of the electric vehicle; in response to the user selection, charging the battery of the electric vehicle; identifying that the electrical charging interface is coupled to a corresponding receiving interface of the electric vehicle; receiving, from an electronic sensor, an indication of an electrical load on the electrical charging interface; determining that the electrical load is below a charging threshold; based on the determination that the electrical load is below the charging threshold, redirecting electric power from to a graphics processing unit instead of to the electrical charging interface; transmitting a signal to cause the graphics processing unit to calculate an original data input from a hashed data string; and in response to the signal, determining the original data input from the hashed data string having a fixed length.

In a 19th Example, the method of Example 18, further comprising appending the original data input to a blockchain.

In a 20th Example, a method of redistributing available electric power, the method comprising: receiving a message packet from an electrical circuit sharing controller of an electric vehicle charger, the message packet comprising an indication to allocate electric power and an amount of electric power associated with the electric vehicle charger; allocating an amount of a total electric power available on the electrical circuit to one or more other chargers of the electric vehicle charger; determining that granting the request would exceed a maximum amount of electric power supported by the electrical circuit; adjusting, based on the determination that granting the request would exceed a maximum amount of electric power supported by the electrical circuit, an amount of electric power allocated to the other electric chargers of the charging station on the circuit; transmitting a signal from the electrical circuit sharing controller to the other electric chargers of the charging stations on the electrical circuit; reducing, based on the signal, an amount of electric power drawn on the electrical circuit, thereby increasing an amount of available electric power; and redistributing the amount of available electric power to a hashed data conversion machine.

### CONCLUSION

Reference throughout this specification to “some embodiments” or “an embodiment” means that a particular feature, structure, or characteristic described in connection with the embodiment is included in at least some embodiments. Thus, appearances of the phrases “in some embodiments” or “in an embodiment” in various places throughout this specification are not necessarily all referring to the same embodiment and may refer to one or more of the same or different embodiments. Furthermore, the particular features, structures or characteristics may be combined in any suitable manner, as would be apparent to one of ordinary skill in the art from this disclosure, in one or more embodiments.

As used in this application, the terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Similarly, it should be appreciated that in the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Rather, inventive aspects lie in a combination of fewer than all features of any single foregoing disclosed embodiment. Accordingly, no feature or group of features is necessary or indispensable to each embodiment.

A number of applications, publications, and external documents may be incorporated by reference herein. Any conflict or contradiction between a statement in the body text of this specification and a statement in any of the incorporated documents is to be resolved in favor of the statement in the body text.

Although described in the illustrative context of certain preferred embodiments and examples, it will be understood by those skilled in the art that the disclosure extends beyond the specifically described embodiments to other alternative embodiments and/or uses and obvious modifications and equivalents. Thus, it is intended that the scope of the claims which follow should not be limited by the particular embodiments described above.

What is claimed is:

1. An electrical energy redirection system comprising:
an electrical power source;
an electrical charging interface configured to couple to a corresponding receiving interface of an electric vehicle within the outdoors, wherein in a coupled configuration the electrical charging interface is configured to charge a battery of the electric vehicle and in an uncoupled configuration the electrical charging interface is configured not to direct electric power to the receiving interface of the electric vehicle;
a data interface configured to receive authorization from a remote computing device for charging the battery of the electric vehicle;
a user interface comprising a display interface, the user interface configured to:
receive user credentials, wherein in response to receiving the user credentials, the data interface is configured to transmit a verification signal via the data interface and to receive the authorization from the remote computing device; and
receive, via the display interface, user selection configured to cause the electrical charging interface to charge the battery of the electric vehicle in the coupled configuration;
a graphics processing unit configured to receive a hashed data string having a fixed length and to determine an original data input therefrom;
at least one air vent configured to prevent environmental debris from contacting the graphics processing unit and to direct ambient outdoor air and toward the graphics processing unit, thereby cooling the graphics processing unit;
a power switching unit comprising:
an electronic sensor configured to identify when the electrical charging interface is coupled to the corresponding receiving interface and charging the battery of the electric vehicle; and
an electronic processor configured to execute instructions, wherein the electronic processor is configured to execute the instructions to at least:
receive from the electronic sensor an indication of an electrical load on the electrical charging interface;
determine that the electrical load is below a charging threshold;
based on the determination that the electrical load is below a charging threshold, redirect electric power from the electrical power source to the graphics processing unit instead of to the electrical charging interface; and
transmit a signal to cause the graphics processing unit to calculate the original data input from the hashed data string.

2. The system of claim 1, wherein the graphics processing unit comprises a hashed data conversion module configured to solve block chain calculations.

3. The system of claim 1, wherein the graphics processing unit comprises a fan system configured to move air through an enclosure of the electrical energy redirection system and discharge the air through the at least one air vent.

4. The system of claim 3, wherein the fan system is configured to allow operation of the graphics processing unit for an extended time in a temperature of up to 90° F.

5. The system of claim 1, wherein the electric power supported by the electrical power source is based on at least one of a duration of electric vehicle charging session, a method of payment account associated with that charging session, a percentage of charging complete, a battery temperature of the electric vehicle, or a time remaining on that charging session.

6. The system of claim 1, wherein the remote computing device comprises an information accessing module configured to enable the user to access charging information on the remote computing device.

7. The system of claim 6, wherein the charging information comprises a number of hours of operation of the electric vehicle or a type of charging connector available at the electrical energy redirection system.

8. The system of claim 6, wherein the information accessing module comprises a user authentication module configured to enable the user to authorize the verification signal received at the electrical energy redirection system and to connect the remote computing device with the electrical energy redirection system over the data interface.

9. The system of claim 6, wherein the information accessing module comprises a payment processing module configured to enable the user to perform one or more payment transactions for charging the electric vehicle at the electrical energy redirection system.

10. The system of claim 6, wherein the information accessing module comprises a location identifying module configured to enable the user to identify a nearby location of one or more electric vehicle charging stations on the remote computing device via the data interface.

11. The system of claim 6, wherein the information accessing module comprises a digital currency monitoring module configured to enable the user to review or update a digital wallet associated with a user account.

12. The system of claim 1, wherein the user interface comprises an information providing module configured to provide charging information on the display interface of the electrical energy redirection system.

13. The system of claim 12, wherein the information providing module comprises an electric charging interface recommending module configured to recommend a type of electric chargers available at the electrical energy redirection system and to enable the user to check on the remote computing device over the data interface.

14. The system of claim 12, wherein the information providing module comprises an hours of operation calculating module configured to calculate a total amount of time charged to the electric vehicle.

15. The system of claim 12, wherein the information providing module comprises a charging cost calculating module configured to calculate a total cost based on a number of hours of operation of the electrical energy redirection system.

16. The system of claim 1, further comprising a network hotspot coupled to the power switching unit, the network hotspot configured to provide extended ranges of coverage by additional, and external antennae.

17. The system of claim 1, wherein the display interface is configured to enable the user to provide user input into the electrical energy redirection system to authenticate user credentials.

18. A method for redirecting electric power from a graphics processing unit to an electrical charging interface, the method comprising:
receiving, via a user interface, user credentials;
in response to receiving the user credentials, transmitting, via a data interface, a verification signal to a remote computing device;
receiving, via the data interface, authorization from the remote computing device for charging a battery of an electric vehicle;
receiving, via a display interface of the user interface, user selection configured to cause the electrical charging interface to charge the battery of the electric vehicle;
in response to the user selection, charging the battery of the electric vehicle;
identifying that the electrical charging interface is coupled to a corresponding receiving interface of the electric vehicle;
receiving, from an electronic sensor, an indication of an electrical load on the electrical charging interface;
determining that the electrical load is below a charging threshold;
based on the determination that the electrical load is below the charging threshold, redirecting electric power from to a graphics processing unit instead of to the electrical charging interface;
transmitting a signal to cause the graphics processing unit to calculate an original data input from a hashed data string; and
in response to the signal, determining the original data input from the hashed data string having a fixed length.

19. The method of claim 18, further comprising appending the original data input to a blockchain.

20. A method of redistributing available electric power, the method comprising:
receiving a message packet from an electrical circuit sharing controller of an electric vehicle charger, the message packet comprising an indication to allocate electric power and an amount of electric power associated with the electric vehicle charger;
allocating an amount of a total electric power available on the electrical circuit to one or more other chargers of the electric vehicle charger;
determining that granting the request would exceed a maximum amount of electric power supported by the electrical circuit;
adjusting, based on the determination that granting the request would exceed a maximum amount of electric power supported by the electrical circuit, an amount of electric power allocated to the other electric chargers of a charging station on the circuit;
transmitting a signal from the electrical circuit sharing controller to the other electric chargers of the charging station on the electrical circuit;
reducing, based on the signal, an amount of electric power drawn on the electrical circuit, thereby increasing an amount of available electric power; and
redistributing the amount of available electric power to a hashed data conversion machine.
